(19) United States
(12) Patent Application Publication
(10) Pub. No.: US 2025/0268158 A1
(43) Pub. Date: Aug. 28, 2025

(54) METHOD FOR GROWING PLANT USING WATER ABSORBING RESIN, AND WATER ABSORBING RESIN AND METHOD FOR PRODUCING SAME

(71) Applicant: UNITIKA LTD., Osaka-shi, Osaka (JP)

(72) Inventors: Yusuke OKITA, Uji-shi, Kyoto (JP); Takashi INAGAKI, Uji-shi, Kyoto (JP)

(21) Appl. No.: 18/996,478

(22) PCT Filed: Aug. 23, 2023
(86) PCT No.: PCT/JP2023/030232

§ 371 Date: Jan. 17, 2025

(30) Foreign Application Priority Data
Aug. 25, 2022 (JP) 2022-133996
Oct. 27, 2022 (JP) 2022-171931
Oct. 27, 2022 (JP) 2022-171932

(51) Int. Cl. A01G 24/35; A01G 20/00; C08K 3/08; C08K 5/09; C08K 5/1515; C08K 5/29; C08L 3/04; C08L 29/04

(52) U.S. Cl. CPC A01G 24/35; A01G 20/00; C08K 3/08; C08K 5/09; C08K 5/1515; C08K 5/29; C08L 3/04; C08L 29/04; C08K 2003/0881

(57) ABSTRACT

Provided is a method for growing a plant using a water-absorbent resin that is less prone to be deactivated by calcium ions, magnesium ions, or the like in soil, water, or a fertilizer. The method includes mixing a first water-absorbent resin containing a crosslinked polyvinyl alcohol and a crosslinked phosphorylated starch or a second water-absorbent resin composed of a crosslinked phosphorylated polyvinyl alcohol into soil to form improved soil, and growing a plant such as turf on the improved soil. The water-absorbent resin is mixed in a granular shape into the soil to afford improved soil. The first water-absorbent resin includes those in which polyvinyl alcohol itself, a phosphorylated starch itself, and polyvinyl alcohol and a phosphorylated starch are crosslinked intermolecularly. The second water-absorbent resin includes one in which a phosphorylated polyvinyl alcohol itself is crosslinked intermolecularly.

### TECHNICAL FIELD

The present invention relates to a method for growing a plant using a water-absorbent resin superior in water absorbability and water retainability, and particularly relates to a method for growing a plant such as turf using a water-absorbent resin capable of maintaining water absorbability and water retainability for a long period of time.

### BACKGROUND ART

Irrigation, namely, watering is essential for the growth of plants. Since the irrigation is wanted to be reduced in frequency or omitted, mixing a superabsorbent resin into soil is performed (Patent Document 1). That is, if the superabsorbent resin having saturatedly absorbed water is put in the soil, water retained by the superabsorbent resin is supplied to a plant even if the frequency of irrigation is reduced, and the plant can be prevented from withering. Examples of the superabsorbent resin used in Patent Document 1 include a saponified product of a starch-acrylonitrile graft copolymer, a neutralized crosslinked product of a starch-acrylic acid graft product, a crosslinked acrylate salt, a crosslinked polyethylene oxide, and a saponified product of a vinyl acetate-unsaturated carboxylic acid (ester) copolymer (Patent Document 1: page 2, upper left column, line 17 to upper right column, line 2).

However, when the superabsorbent resin described in Patent Document 1 is used for a long period of time while being mixed with soil and irrigated, the water absorption capacity and water retention capacity may be deteriorated. This is because carboxyl groups in the superabsorbent resin are deactivated by calcium ions, magnesium ions, or the like in soil, water (particularly hard water), or a fertilizer (Non-Patent Document 1).

On the other hand, a phosphorylated polyvinyl alcohol crosslinked with glutaraldehyde is known as a superabsorbent resin, (Non-Patent Document 2), and this is described to well adsorb calcium ions (Non-Patent Document 2, p. 2301, paragraph of absorption of calcium ions). For this reason, it is considered that a crosslinked phosphorylated polyvinyl alcohol is also deactivated by calcium ions in soil, water, or a fertilizer.

### PRIOR ART DOCUMENTS

### Patent Document

Patent Document 1: JP-A-59-823

### Non-Patent Documents

Non-Patent Document 1: Masamichi TAKAHASHI, Kazuki SHIBASAKI, Eichiro NAKAMA, Moriyoshi ISHIZUKA, and Seiichi OHTA, “Application of Superabsorbent Polymers in Forestry and Revegetation Fields”, Journal of the Japanese Forest Society (2018) 100:229-236
Non-Patent Document 2: Ying An, Toshiki Koyama, Kenji Hanabusa, Hirofusa Shirai, Junichi Ikeda, Hajime Yono and Takashi Itoh “Preparation and properties of highly phosphorylated poly (vinyl alcohol) hydrogels chemically crosslinked by glutaraldehyde”, POLYMER (1995) Volume 36 Number 11:2297-2301

### SUMMARY OF THE INVENTION

### Problems to be Solved by the Invention

An object of the present invention is to provide a method for growing a plant using a water-absorbent resin that is less prone to be deactivated by calcium ions, magnesium ions, or the like in soil, water, or a fertilizer.

### Solutions to the Problems

The present invention has solved the above problems by developing a water-absorbent resin which includes a crosslinked polyvinyl alcohol and a crosslinked phosphorylated starch. That is, the present invention relates to a method for growing a plant by mixing a water-absorbent resin with soil, the water-absorbent resin including a crosslinked polyvinyl alcohol and a crosslinked phosphorylated starch (this water-absorbent resin is hereinafter referred to as “first water-absorbent resin”) to obtain improved soil, and growing a plant on the improved soil. The present invention also relates to a first water-absorbent resin and a method for producing the same.

In addition, the present invention has been solved the problems described above by finding that the water absorption capacity is less prone to decrease even when a crosslinked phosphorylated polyvinyl alcohol is allowed to absorb calcium ion water, dried, and then allowed to absorb calcium ion water again. That is, the present invention relates to a method for growing a plant, the method comprising mixing a water-absorbent resin with soil, the water-absorbent resin including a crosslinked phosphorylated polyvinyl alcohol (this water-absorbent resin is hereinafter referred to as “second water-absorbent resin”) to obtain improved soil, and growing a plant on the improved soil.

The first water-absorbent resin used in the present invention contains a crosslinked polyvinyl alcohol and a crosslinked phosphorylated starch. Specifically, there is a form in which polyvinyl alcohol itself crosslinked intermolecularly or a phosphorylated starch itself crosslinked intermolecularly is mixed, or a form in which polyvinyl alcohol and a phosphorylated starch are crosslinked intermolecularly, and there is also a form in which both the aforementioned forms are mixed.

The polyvinyl alcohol to be used for obtaining the first water-absorbent resin is preferably a partially saponified polyvinyl alcohol, and a polyvinyl alcohol having a degree of saponification of about 70 to 90% is preferable. The degree of polymerization is preferably about 1000 to 10,000. The polyvinyl alcohol may be a carboxylated polyvinyl alcohol or a phosphorylated polyvinyl alcohol. The carboxylated polyvinyl alcohol has a carboxyl group in addition to a hydroxy group and an acetyl group of polyvinyl alcohol. The phosphorylated polyvinyl alcohol has a phosphate group in addition to a hydroxy group and an acetyl group of polyvinyl alcohol. Due to the presence of the phosphate group, the water-absorbent resin maintains water absorption capacity and water retention capacity for a long period of time. The crosslinked phosphorylated starch has a phosphate group and is crosslinked, and is commercially available as a type of processed starch.

The second water-absorbent resin used in the present invention contains a crosslinked phosphorylated polyvinyl alcohol. The crosslinked phosphorylated polyvinyl alcohol is a product obtained by phosphorylating polyvinyl alcohol and then crosslinking the phosphorylated polyvinyl alcohol. The polyvinyl alcohol to be used is preferably a partially saponified polyvinyl alcohol, and a polyvinyl alcohol having a degree of saponification of about 70 to 90% is preferable. The degree of polymerization is preferably about 1000 to 10,000. Further, the polyvinyl alcohol may be a carboxylated polyvinyl alcohol.

The first water-absorbent resin and the second water-absorbent resin (hereinafter, both are simply referred to as “water-absorbent resin”) are each used by being mixed with soil. The soil may be either natural soil or artificial soil. The water-absorbent resin preferably has a shape similar to that of earth and sand forming soil, and in general, preferably has a granular shape. In addition, the size of the water-absorbent resin is also preferably about the same as the earth and sand, and specifically, the mass average particle diameter is preferably 50 to 10,000 μm.

The water-absorbent resin to be used in the present invention may be supported on a nonwoven fabric and used as a water-absorbent nonwoven fabric. Such a water-absorbent nonwoven fabric is used by being laid on the soil or under the soil, or by being buried under a soil surface layer. As the nonwoven fabric, a conventionally known nonwoven fabric can be employed, but it is preferable to employ a biodegradable nonwoven fabric that is to be biodegraded in soil. As the biodegradable nonwoven fabric, those containing cotton fibers or polylactic acid fibers as constituent fibers can be employed. When a water-absorbent nonwoven fabric is used, a plant can be grown even in the absence of soil. For example, it is also possible to grow a plant by laying a water-absorbent nonwoven fabric on a rooftop or a wall surface of a building and sowing seeds of the plant or planting seedlings of the plant on a surface of the water-absorbent nonwoven fabric. Such a method for growing a plant can also be used as a method for greening a building rooftop or a method for greening a building wall surface. It is also possible to grow a plant by sowing seeds of the plant or planting seedlings of the plant on a surface of a porous material such as a sponge on which a water-absorbent resin is supported or a fibrous aggregate of natural fibers, synthetic fibers, mineral fibers, or the like on which a water-absorbent resin is supported in place of the water-absorbent nonwoven fabric.

A water-absorbent resin can be supported on a nonwoven fabric by bonding the water-absorbent resin to the nonwoven fabric with a binder. For example, a granular water-absorbent resin may be bonded to and supported on a surface of the constituent fibers of the nonwoven fabric with a binder, or a film-like water-absorbent resin may be bonded to and supported on a surface of a nonwoven fabric with a binder. As the binder, a conventionally known binder can be used, but a water-soluble binder is preferable. For example, it is preferable to use a water-soluble binder such as hydroxypropyl cellulose, carboxymethyl cellulose, or an alginate salt. Further, the water-absorbent resin may be deposited in gaps between constituent fibers of the nonwoven fabric without a binder.

The first water-absorbent resin can be produced by the following method. That is, the method is a method including mixing polyvinyl alcohol, a phosphorylated starch, a crosslinking agent, and water to form a slurry, and heating the slurry to dryness at 100° C. to 140° C. As described above, the polyvinyl alcohol is preferably a partially saponified polyvinyl alcohol, a carboxylated polyvinyl alcohol, or a phosphorylated polyvinyl alcohol. The partially saponified polyvinyl alcohol and the carboxylated polyvinyl alcohol are conventionally known, and commercially available products may be used. As the phosphorylated polyvinyl alcohol, it is preferable to use a product produced by the following method. That is, a phosphorylated polyvinyl alcohol can be produced by a method including heating an aqueous solution obtained by mixing polyvinyl alcohol, phosphoric acid and/or a salt thereof, urea, and water to dryness at 100° C. to 140° C., and washing. As the phosphoric acid and/or a salt thereof, phosphoric acid, a phosphate salt, a hydrogen phosphate salt, or a dihydrogen phosphate salt is used. In the present invention, it is preferable to use dipotassium hydrogen phosphate or potassium dihydrogen phosphate. A phosphorylated polyvinyl alcohol can be obtained by heating the aforementioned aqueous solution to 100° C. to 140° C. and then washing, thereby allowing a phosphate group (quaternary ammonium phosphate group) to bond to a hydroxy group of the polyvinyl alcohol. In addition, when quaternary ammonium ions are replaced by potassium ions, sodium ions, or the like, a phosphorylated polyvinyl alcohol containing less nitrogen atoms can be obtained.

The phosphorylated starch is known as a type of processed starch, and a commercially available product may be employed. As the crosslinking agent, a polyfunctional compound capable of crosslinking polyvinyl alcohol and starch may be used. Since the first water-absorbent resin is produced via a reaction in water, it is preferable to use a water-soluble polyfunctional compound. As the polyfunctional compound, a polyfunctional isocyanate compound, a polyfunctional titanium compound, a polyfunctional epoxy compound, a polyfunctional carboxylic acid, or the like may be used singly or in combination. In general, a bifunctional compound such as a diisocyanate compound, a diglycidyl compound, or a dicarboxylic acid compound is used.

Polyvinyl alcohol, a phosphorylated starch, a crosslinking agent, and water are mixed to afford a slurry, and then the slurry is heated to 100° C. to 140° C., whereby the polyvinyl alcohol and the phosphorylated starch are crosslinked to afford a first water-absorbent resin having a three-dimensional network structure. In addition, by heating to 100° C. to 140° C., water is evaporated, and a solid first water-absorbent resin is obtained.

A water-absorbent nonwoven fabric may also be obtained by mixing polyvinyl alcohol, a phosphorylated starch, a crosslinking agent, and water, impregnating the resulting slurry into a nonwoven fabric, and then heating the nonwoven fabric to 100° C. to 140° C. The slurry impregnated in the nonwoven fabric becomes a first water-absorbent resin having a three-dimensional network structure in an impregnated state, and is deposited as a solid first water-absorbent resin in gaps between constituent fibers of the nonwoven fabric.

The first water-absorbent resin can be used for conventionally known applications, but is preferably used in soil for plant growth because the first water-absorbent resin is hardly deteriorated in water absorption capacity and water retention capacity particularly by calcium ions, magnesium ions, or the like in soil or the like. For example, the first water-absorbent resin is mixed with earth and sand in the soil to form improved soil that maintains water absorption capacity and water retention capacity for a long period of time, and a plant can be grown with an amount of water supplied for irrigation reduced with the improved soil. In this case, the first water-absorbent resin may be used together with an antibacterial agent in order to suppress biodegradation of the first water-absorbent resin. The first water-absorbent resin is preferably used particularly for growing turf with a large amount of water supplied for irrigation. Specifically, the first water-absorbent resin is added to soil to afford improved soil, and lawn seeds are sown on the improved soil, or sods are laid to perform turf filling. As a result, the amount of water supplied for irrigation can be reduced, which contributes to water saving. Needless to say, the first water-absorbent resin can also be used for the growth of plants such as vegetables and fruit trees, foliage plants, or the like, which are frequently irrigated, besides turf.

The second water-absorbent resin can be produced, for example, by the following method. First, an aqueous solution obtained by mixing polyvinyl alcohol, phosphoric acid and/or a salt thereof, urea, and water is heated to dryness at 100° C. to 140° C. and washed to afford a phosphorylated polyvinyl alcohol. The resulting phosphorylated polyvinyl alcohol is a product formed by bonding a phosphate group (quaternary ammonium phosphate group) to a hydroxy group of the polyvinyl alcohol. In addition, when quaternary ammonium ions are replaced by potassium ions, sodium ions, or the like, a phosphorylated polyvinyl alcohol containing less nitrogen atoms can be obtained. Then, the phosphorylated polyvinyl alcohol, a crosslinking agent, and water are mixed to afford a slurry, and then the slurry is heated to 100° C. to 140° C., whereby the phosphorylated polyvinyl alcohol is crosslinked to afford a second water-absorbent resin composed of a crosslinked phosphorylated polyvinyl alcohol having a three-dimensional network structure. In addition, by heating to 100° C. to 140° C., water is evaporated, and a second water-absorbent resin composed of a solid crosslinked phosphorylated polyvinyl alcohol is obtained. As the crosslinking agent, the crosslinking agent used in the production of the first water-absorbent resin can be used, and in general, a bifunctional compound such as a diisocyanate compound, a diglycidyl compound, or a dicarboxylic acid compound is used.

The phosphorylated polyvinyl alcohol, a crosslinking agent, and water are mixed to afford a slurry, and the slurry is impregnated into a nonwoven fabric, and then the nonwoven fabric is heated to 100° C. to 140° C. to afford a water-absorbent nonwoven fabric in which a second water-absorbent resin composed of a crosslinked phosphorylated polyvinyl alcohol is supported without a binder. That is, a water-absorbent nonwoven fabric is obtained in which the second water-absorbent resin composed of the crosslinked phosphorylated polyvinyl alcohol is deposited without a binder in gaps between constituent fibers of the nonwoven fabric.

The second water-absorbent resin is preferably used in soil for plant growth because the second water-absorbent resin is hardly deteriorated in water absorption capacity and water retention capacity by calcium ions, magnesium ions, or the like in soil or the like. For example, the first water-absorbent resin is mixed with earth and sand in the soil to form improved soil that maintains water absorption capacity and water retention capacity for a long period of time, and a plant can be grown with an amount of water supplied for irrigation reduced with the improved soil. In this case, the second water-absorbent resin may be used together with an antibacterial agent in order to suppress biodegradation of the second water-absorbent resin. The second water-absorbent resin is preferably used particularly for growing turf with a large amount of water supplied for irrigation. Specifically, the second water-absorbent resin is added to soil to afford improved soil, and lawn seeds are sown on the improved soil, or sods are laid to perform turf filling. As a result, the amount of water supplied for irrigation can be reduced, which contributes to water saving. Needless to say, the first water-absorbent resin can also be used for the growth of plants such as vegetables and fruit trees, foliage plants, or the like, which are frequently irrigated, besides turf.

### Effects of the Invention

Since the first water-absorbent resin has water absorption capacity and water retention capacity due to a phosphate group, the water absorption capacity and the water retention capacity are hardly deteriorated due to the influence of calcium ions, magnesium ions, and the like. Therefore, the first water-absorbent resin can be used for growing a plant using soil or a fertilizer rich in calcium ions, magnesium ions, and the like. In addition, since the first water-absorbent resin contains both a crosslinked polyvinyl alcohol and a crosslinked phosphorylated starch, the first water-absorbent resin has moderate toughness and brittleness, and thus has an effect of being easily granulated and easy to handle.

When the second water-absorbent resin absorbs calcium ion water absorbs and is dried, and then absorbs calcium ion water for a second time, the second water absorption capacity of the second water-absorbent resin hardly decreases. Therefore, even if the second water-absorbent resin is mixed in soil rich in calcium ions, magnesium ions, and the like, the second water-absorbent resin can maintain high water absorption capacity for a long period of time. In addition, the water absorption capacity is less prone to decrease due to the influence of calcium ions, magnesium ions, and the like contained in a fertilizer or water. Therefore, when a plant is grown using the second water-absorbent resin, it is possible to prevent the plant from withering and to save water even when the frequency of irrigation to the plant is reduced.

### EXAMPLES

### <Production of First Water-Absorbent Resin (1)>

40 parts by mass of partially saponified polyvinyl alcohol (JP-33 manufactured by JAPAN VAM & POVAL CO., LTD.), 60 parts by mass of phosphorylated starch (SPRET #250 manufactured by NIHON SHOKUHIN KAKO CO., LTD.), and 1900 parts by mass of water were mixed and stirred, and 5 parts by mass of a water-soluble isocyanate aqueous dispersion (ELASTRON BN-69 manufactured by DKS Co., Ltd., diisocyanate content: 40 wt %) was added thereto and stirred, affording a slurry. The slurry was heated and dried in a petri dish with a hot air dryer at 120° C. for 120 minutes, affording a film-like first water-absorbent resin (1).

### <Production of First Water-Absorbent Resin (2)>

40 parts by mass of carboxylated polyvinyl alcohol (AF-17 manufactured by JAPAN VAM & POVAL CO., LTD.), 60 parts by mass of phosphorylated starch (SPRET #250 manufactured by NIHON SHOKUHIN KAKO CO., LTD.), and 1900 parts by mass of water were mixed and stirred, and 100 parts by mass of polyethylene glycol #400 diglycidyl ether (EPOLIGHT 400E manufactured by Kyoeisha Chemical Co., Ltd.) was added thereto and stirred, affording a slurry. The slurry was heated and dried in a petri dish with a hot air dryer at 110° C. for 120 minutes, affording a film-like first water-absorbent resin (2).

### <Production of First Water-Absorbent Resin (3)>

5 parts by mass of polyvinyl alcohol (JP-33 manufactured by JAPAN VAM & POVAL CO., LTD.), 95 parts by mass of water, 3.5 parts by mass of potassium dihydrogen phosphate, and 2.5 parts by mass of urea were mixed and stirred, affording an aqueous solution. This aqueous solution was heated to dryness at 120° C. for 180 minutes. The solid obtained was dissolved in water again and washed with a dialysis membrane (cellulose tube for dialysis, manufactured by KENIS LIMITED), affording phosphorylated polyvinyl alcohol.

80 parts by mass of the phosphorylated polyvinyl alcohol obtained, 20 parts by mass of phosphorylated starch (SPRET #250 manufactured by NIHON SHOKUHIN KAKO CO., LTD.), and 1900 parts by mass of water were mixed and stirred, and 100 parts by mass of polyethylene glycol #400 diglycidyl ether (EPOLIGHT 400E manufactured by Kyoeisha Chemical Co., Ltd.) was added thereto and stirred, affording a slurry. The slurry was heated and dried in a petri dish with a hot air dryer at 110° C. for 120 minutes, affording a film-like first water-absorbent resin (3).

### <Production of First Water-Absorbent Resin (4)>

A film-like first water-absorbent resin (4) was obtained by the same method as in <Production of first water-absorbent resin (3)>except that the parts by mass of the phosphorylated polyvinyl alcohol was changed to 60 parts by mass and the parts by mass of the phosphorylated starch was changed to 40 parts by mass.

### <Production of First Water-Absorbent Resin (5)>

A film-like first water-absorbent resin (5) was obtained by the same method as in <Production of first water-absorbent resin (3)>except that the parts by mass of the phosphorylated polyvinyl alcohol was changed to 50 parts by mass and the parts by mass of the phosphorylated starch was changed to 50 parts by mass.

### <Production of First Water-Absorbent Resin (6)>

A film-like first water-absorbent resin (6) was obtained by the same method as in <Production of first water-absorbent resin (3)>except that the parts by mass of the phosphorylated polyvinyl alcohol was changed to 40 parts by mass and the parts by mass of the phosphorylated starch was changed to 60 parts by mass.

### <Production of First Water-Absorbent Resin (7)>

A film-like first water-absorbent resin (7) was obtained by the same method as in <Production of first water-absorbent resin (3)>except that the parts by mass of the phosphorylated polyvinyl alcohol was changed to 20 parts by mass and the parts by mass of the phosphorylated starch was changed to 80 parts by mass.

### <Production of First Water-Absorbent Resin (8)>

A film-like first water-absorbent resin (8) was obtained by the same method as in <Production of first water-absorbent resin (5)>except that the parts by mass of the polyethylene glycol #400 diglycidyl ether (EPOLIGHT 400E manufactured by Kyoeisha Chemical Co., Ltd.) was changed to 50 parts by mass.

### <Production of First Water-Absorbent Resin (9)>

A film-like first water-absorbent resin (9) was obtained by the same method as in <Production of first water-absorbent resin (5)>except that the parts by mass of the polyethylene glycol #400 diglycidyl ether (EPOLIGHT 400E manufactured by Kyoeisha Chemical Co., Ltd.) was changed to 20 parts by mass.

### <Production of First Water-Absorbent Resin (10)>

50 parts by mass of the phosphorylated polyvinyl alcohol used in <Production of first water-absorbent resin (3)>, 50 parts by mass of phosphorylated starch (SPRET #250 manufactured by NIHON SHOKUHIN KAKO CO., LTD.), and 1900 parts by mass of water were mixed and stirred, and 5 parts by mass of a water-soluble isocyanate aqueous dispersion (ELASTRON BN-69 manufactured by DKS Co., Ltd., diisocyanate content: 40 wt %) was added thereto and stirred, affording a slurry. The slurry was heated and dried in a petri dish with a hot air dryer at 120° C. for 120 minutes, affording a film-like first water-absorbent resin (10).

### <Production of First Water-Absorbent Resin (11)>

A film-like first water-absorbent resin (10) was obtained by the same method as in <Production of first water-absorbent resin (11)>except for using 35 parts by mass of titanium diisopropoxybis (triethanolaminato) (ORGATIX TC-400 manufactured by Matsumoto Fine Chemical Co., Ltd., Ti content: 8.2 wt %) in place of 5 parts by mass of the water-soluble isocyanate aqueous dispersion (ELASTRON BN-69 manufactured by DKS Co., Ltd., diisocyanate content: 40 wt %).

### <Production of First Water-Absorbent Resin (12)>

A film-like first water-absorbent resin (12) was obtained in the same manner as in <Production of first water-absorbent resin (10)>except for using 30 parts by mass of succinic acid (manufactured by KANTO CHEMICAL CO., INC.) in place of 5 parts by mass of the water-soluble isocyanate aqueous dispersion (ELASTRON BN-69 manufactured by DKS Co., Ltd., diisocyanate content: 40 wt %) and changing the temperature of the dry hot air blower to 130° C.

### <Production of Comparative Water-Absorbent Resin (1)>

A film-like comparative water-absorbent resin (1) was obtained by the same method as in <Production of first water-absorbent resin (1)>except that the phosphorylated starch (SPRET #250 manufactured by NIHON SHOKUHIN KAKO CO., LTD.) was not used and the parts by mass of the partially saponified polyvinyl alcohol (JP-33 manufactured by JAPAN VAM & POVAL CO., LTD.) was changed to 100 parts by mass.

### <Production of Comparative Water-Absorbent Resin (2)>

A film-like comparative water-absorbent resin (2) was obtained by the same method as in <Production of first water-absorbent resin (1)>except that 100 parts by mass of partially saponified polyvinyl alcohol (JP-33 manufactured by JAPAN VAM & POVAL CO., LTD.) was changed to 100 parts by mass of carboxylated polyvinyl alcohol (AF-17 manufactured by JAPAN VAM & POVAL CO., LTD.).

### <Production of Comparative Water-Absorbent Resin (3)>

A film-like comparative water-absorbent resin (3) was obtained by the same method as in <Production of first water-absorbent resin (3)>except that the phosphorylated polyvinyl alcohol was not used and the parts by mass of the phosphorylated starch (SPRET #250 manufactured by NIHON SHOKUHIN KAKO CO., LTD.) was changed to 100 parts by mass.

### <Production of Comparative Water-Absorbent Resin (4)>

A film-like comparative water-absorbent resin (4) was obtained by the same method as in <Production of first water-absorbent resin (11)>except that the phosphorylated polyvinyl alcohol was not used and the parts by mass of the phosphorylated starch (SPRET #250 manufactured by NIHON SHOKUHIN KAKO CO., LTD.) was changed to 100 parts by mass.

### <Production of Comparative Water-Absorbent Resin (5)>

A film-like comparative water-absorbent resin (5) was obtained by the same method as in <Production of first water-absorbent resin (12)>except that the phosphorylated polyvinyl alcohol was not used and the parts by mass of the phosphorylated starch (SPRET #250 manufactured by NIHON SHOKUHIN KAKO CO., LTD.) was changed to 100 parts by mass.

### <Comparative Water-Absorbent Resin (6)>

A commercially available water-absorbent resin (superabsorbent resin manufactured by KENIS LIMITED) was obtained and used as a comparative water-absorbent resin (6).

### <Comparative Water-Absorbent Resin (7)>

A commercially available water-absorbent resin (SuperSorb-F manufactured by The Aquatrols Company) was obtained and used as a comparative water-absorbent resin (7).

The water absorption ratio, the toughness, and the brittleness of each of the first water-absorbent resins (1) to (12) and the comparative water-absorbent resins (1) to (7) were evaluated by the following methods. These results are shown in Table 1.

### [Deionized Water Absorption Ratio]

1 part by mass of a water-absorbent resin was immersed in 500 parts by mass of deionized water, and left at rest at room temperature for 1 hour. After removing soluble components, the mass (W1) of the water-absorbent resin swollen with the deionized water is measured. Thereafter, the water-absorbent resin swollen with the deionized water is dried up in a hot air dryer at a temperature of 105° C., and the dry-up mass (W2) is measured. The value of W1/W2 was taken as a deionized water absorption ratio. The deionized water absorption ratio is denoted as water absorption ratio α in Table 1.

### [Calcium Ion Water Absorption Ratio]

1 part by mass of calcium chloride dihydrate (special grade reagent manufactured by KANTO CHEMICAL CO., INC.) was dissolved in 100 parts by mass of water to obtain calcium ion water. 1 part by mass of a water-absorbent resin was immersed in 100 parts by mass of the calcium ion water, and left at rest at room temperature for 1 hour. After removing soluble components, the mass (X1) of the water-absorbent resin swollen with the calcium ion water is measured. Thereafter, the water-absorbent resin swollen with the calcium ion water is dried up in a hot air dryer at a temperature of 105° C., and the dry-up mass (X2) is measured. The value of X1/X2 was taken as calcium ion water absorption ratio. The calcium ion water absorption ratio is denoted as water absorption ratio β in Table 1.

### [Calcium Ion Water Re-Absorption Ratio]

A water-absorbent resin swollen with calcium ion water was obtained by the same method as the method for measuring the calcium ion water absorption ratio. The water-absorbent resin swollen with calcium ion water is dried in a hot air dryer at a temperature of 70° C. to afford a quasi-dried matter, and the mass (Y1) of the quasi-dried matter is measured. Thereafter, 1 part by mass of the quasi-dried matter was immersed in 100 parts by mass of calcium ion water, and left at rest at room temperature for 1 hour. After removing soluble components, the mass (Y2) of the water-absorbent resin swollen with the calcium ion water is measured. The value of Y2/Y1 was taken as calcium ion water re-absorption ratio. The calcium ion water re-absorption ratio is denoted as water absorption ratio γ in Table 1.

### [Toughness and Brittleness]

The film-like first water-absorbent resins (1) to (12) and the film-like comparative water-absorbent resins (1) to (5) were each pulled with both hands, and those cut at a low elongation were evaluated as “low” in toughness, those cut at a medium elongation were evaluated as “medium” in toughness, and those cut at a high elongation were evaluated as “high” in toughness. In addition, those cut at low strength were evaluated as “high” in brittleness, those cut at medium strength were evaluated as “medium” in brittleness, and those cut at high strength were evaluated as “low” in brittleness. One being “medium” in toughness and “medium” in brittleness is preferable because it is easy to handle and tends to be formed into a granular shape. The comparative water-absorbent resins (6) and (7) are originally granular, and therefore neither toughness nor brittleness is evaluated.

TABLE 1

| | | | | |
|---|---|---|---|---|
| Water | Water | Water | | |
| absorption | absorption | absorption | | |
| ratio α | ratio β | ratio γ | Toughness | Brittleness |

First water-absorbent resin

| | | | | | |
|---|---|---|---|---|---|
| (1) | 32 | 18 | 16 | Medium | Medium |
| (2) | 34 | 17 | 17 | Medium | Medium |
| (3) | 52 | 20 | 22 | Medium | Medium |
| (4) | 65 | 20 | 23 | Medium | Medium |
| (5) | 69 | 21 | 24 | Medium | Medium |
| (6) | 72 | 21 | 24 | Medium | Medium |
| (7) | 44 | 20 | 21 | Medium | Medium |
| (8) | 85 | 20 | 26 | Medium | Medium |
| (9) | 132 | 21 | 31 | Medium | Medium |
| (10) | 90 | 18 | 23 | Medium | Medium |
| (11) | 45 | 20 | 21 | Medium | Medium |
| (12) | 65 | 20 | 23 | Medium | Medium |

Comparative water-absorbent resin

| | | | | | |
|---|---|---|---|---|---|
| (1) | 7 | 8 | 7 | High | Low |
| (2) | 8 | 7 | 5 | High | Low |
| (3) | 64 | 18 | 20 | Low | High |
| (4) | 63 | 18 | 22 | Low | High |
| (5) | 102 | 19 | 24 | Low | High |
| (6) | 465 | 10 | 4 | — | — |
| (7) | 414 | 5 | 3 | — | — |

As can be seen from the results in Table 1, the first water-absorbent resins (1) to (12) are high in all water absorption ratios of the deionized water absorption ratio, the calcium ion absorption ratio, and the calcium ion re-absorption ratio, and exhibit good water absorbability even when hard water rich in calcium ions is supplied for irrigation. Therefore, the first water-absorbent resins can be applied to soil when growing a plant. In addition, since the first water-absorbent resins are medium in toughness and brittleness, these are easy to handle and are easy to granulate.

On the other hand, the comparative water-absorbent resins (1) and (2) were low in all the water absorption ratios, and therefore were not suitable as water-absorbent resins. In addition, since the comparative water-absorbent resins were low in brittleness, these were difficult to granulate. The comparative water-absorbent resins (3) to (5) were high in all the water absorption ratios, and therefore can be applied to soil, but are difficult to handle because of their low toughness and high brittleness. The comparative water-absorbent resins (6) and (7) are high in deionized water absorption ratio but low in calcium ion water absorption ratio and calcium ion water re-absorption ratio, and they extremely deteriorate in water absorbability when hard water is supplied for irrigation. Therefore, the comparative water-absorbent resins are unsuitable as water-absorbent resins that can be applied to soil.

### <Production of Second Water-Absorbent Resin (1)>

5 parts by mass of partially saponified polyvinyl alcohol (JP-33 manufactured by JAPAN VAM & POVAL CO., LTD.) was mixed with 95 parts by mass of water under stirring and dissolved, and then 3.5 parts by mass of dipotassium hydrogen phosphate and 2.5 parts by mass of urea were added and stirred, affording an aqueous solution. This aqueous solution was transferred to a square tray, heated to dryness at 105° C. for 120 minutes in an oven, and then heated at 140° C. for 30 minutes, affording a solid. This solid was dissolved in water again and washed with a dialysis membrane (cellulose tube for dialysis, manufactured by KENIS LIMITED), affording phosphorylated polyvinyl alcohol. The result of phosphorus quantification by ICP of the obtained phosphorylated polyvinyl alcohol was 0.44 wt %.

100 parts by mass of the obtained phosphorylated polyvinyl alcohol was mixed with and dissolved in 1900 parts by mass of water under stirring, and 5 parts by mass of a water-soluble isocyanate aqueous dispersion (ELASTRON BN-69 manufactured by DKS Co., Ltd., isocyanate content: 40 wt %) was added thereto and stirred, affording a slurry. The slurry was heated and dried in a petri dish with a hot air dryer at 120° C. for 120 minutes, affording a film-like second water-absorbent resin (1).

### <Production of Second Water-Absorbent Resin (2)>

A film-like second water-absorbent resin (2) was obtained by the same method as in <Production of second water-absorbent resin (1)>except that the addition amount of the water-soluble isocyanate aqueous dispersion was changed to 2.5 parts by mass.

### <Production of Second Water-Absorbent Resin (3)>

A film-like second water-absorbent resin (3) was obtained by the same method as in <Production of second water-absorbent resin (1)>except for using 35 parts by mass of titanium diisopropoxybis (triethanolaminato) (ORGATIX TC-400 manufactured by Matsumoto Fine Chemical Co., Ltd., Ti content: 8.2 wt %) in place of the water-soluble isocyanate aqueous dispersion.

### <Production of Second Water-Absorbent Resin (4)>

A film-like second water-absorbent resin (4) was obtained by the same method as in <Production of second water-absorbent resin (1)>except that 100 parts by mass of polyethylene glycol #400 diglycidyl ether (EPOLIGHT 400E manufactured by Kyoeisha Chemical Co., Ltd.) was used in place of the water-soluble isocyanate aqueous dispersion, and the temperature of the hot air dryer was changed to 110° C.

### <Production of Second Water-Absorbent Resin (5)>

A film-like second water-absorbent resin (5) was obtained by the same method as in <Production of second water-absorbent resin (4)>except that the use amount of the polyethylene glycol #400 diglycidyl ether (EPOLIGHT 400E manufactured by Kyoeisha Chemical Co., Ltd.) was changed to 50 parts by mass.

### <Production of Second Water-Absorbent Resin (6)>

A film-like second water-absorbent resin (6) was obtained by the same method as in <Production of second water-absorbent resin (4)>except for using 30 parts by mass of succinic acid (manufactured by KANTO CHEMICAL CO., INC.) in place of the polyethylene glycol #400 diglycidyl ether.

### <Production of Second Water-Absorbent Resin (7)>

5 parts by mass of partially saponified polyvinyl alcohol (JP-33 manufactured by JAPAN VAM & POVAL CO., LTD.) was mixed with 95 parts by mass of water under stirring and dissolved, and then 3.5 parts by mass of dipotassium hydrogen phosphate and 2.5 parts by mass of urea were added and stirred, affording an aqueous solution. This aqueous solution was transferred to a square tray, and heated to dryness at 140° C. for 180 minutes in an oven, affording a solid. This solid was dissolved in water again and washed with a dialysis membrane (cellulose tube for dialysis, manufactured by KENIS LIMITED), affording phosphorylated polyvinyl alcohol. The result of phosphorus quantification by ICP of the obtained phosphorylated polyvinyl alcohol was 1.75 wt %.

100 parts by mass of the obtained phosphorylated polyvinyl alcohol was mixed with and dissolved in 1900 parts by mass of water under stirring, and 5 parts by mass of a water-soluble isocyanate aqueous dispersion (ELASTRON BN-69 manufactured by DKS Co., Ltd., isocyanate content: 40 wt %) was added thereto and stirred, affording a slurry. The slurry was heated and dried in a petri dish with a hot air dryer at 120° C. for 120 minutes, affording a film-like second water-absorbent resin (7).

### <Production of Second Water-Absorbent Resin (8)>

A film-like second water-absorbent resin (8) was obtained by the same method as in <Production of second water-absorbent resin (7)>except that the addition amount of the water-soluble isocyanate aqueous dispersion was changed to 2.5 parts by mass.

### <Production of Second Water-Absorbent Resin (9)>

A film-like second water-absorbent resin (9) was obtained by the same method as in <Production of second water-absorbent resin (7)>except for using 35 parts by mass of titanium diisopropoxybis (triethanolaminato) (ORGATIX TC-400 manufactured by Matsumoto Fine Chemical Co., Ltd., Ti content: 8.2 wt %) in place of the water-soluble isocyanate aqueous dispersion.

### <Production of Second Water-Absorbent Resin (10)>

A film-like second water-absorbent resin (10) was obtained by the same method as in <Production of second water-absorbent resin (7)>except that 100 parts by mass of polyethylene glycol #400 diglycidyl ether (EPOLIGHT 400E manufactured by Kyoeisha Chemical Co., Ltd.) was used in place of the water-soluble isocyanate aqueous dispersion, and the temperature of the hot air dryer was changed to 110° C.

### <Production of Second Water-Absorbent Resin (11)>

A film-like second water-absorbent resin (11) was obtained by the same method as in <Production of second water-absorbent resin (10)>except that the use amount of the polyethylene glycol #400 diglycidyl ether (EPOLIGHT 400E manufactured by Kyoeisha Chemical Co., Ltd.) was changed to 50 parts by mass.

### <Production of Second Water-Absorbent Resin (12)>

A film-like second water-absorbent resin (12) was obtained by the same method as in <Production of second water-absorbent resin (10)>except for using 30 parts by mass of succinic acid (manufactured by KANTO CHEMICAL CO., INC.) in place of the polyethylene glycol #400 diglycidyl ether.

### <Production of Comparative Water-Absorbent Resin (8)>

A film-like comparative water-absorbent resin (8) was obtained by the same method as in <Production of second water-absorbent resin (1)>except for using partially saponified polyvinyl alcohol (JP-33 manufactured by JAPAN VAM & POVAL CO., LTD.) in place of the phosphorylated polyvinyl alcohol.

### <Production of Comparative Water-Absorbent Resin (9)>

A film-like comparative water-absorbent resin (9) was obtained by the same method as in <Production of second water-absorbent resin (2)>except for using partially saponified polyvinyl alcohol (JP-33 manufactured by JAPAN VAM & POVAL CO., LTD.) in place of the phosphorylated polyvinyl alcohol.

### <Production of Comparative Water-Absorbent Resin (10)>

A film-like comparative water-absorbent resin (10) was obtained by the same method as in <Production of second water-absorbent resin (3)>except for using partially saponified polyvinyl alcohol (JP-33 manufactured by JAPAN VAM & POVAL CO., LTD.) in place of the phosphorylated polyvinyl alcohol.

### <Production of Comparative Water-Absorbent Resin (11)>

A film-like comparative water-absorbent resin (11) was obtained by the same method as in <Production of second water-absorbent resin (4)>except for using partially saponified polyvinyl alcohol (JP-33 manufactured by JAPAN VAM & POVAL CO., LTD.) in place of the phosphorylated polyvinyl alcohol.

### <Production of Comparative Water-Absorbent Resin (12)>

A film-like comparative water-absorbent resin (12) was obtained by the same method as in <Production of second water-absorbent resin (6)>except for using partially saponified polyvinyl alcohol (JP-33 manufactured by JAPAN VAM & POVAL CO., LTD.) in place of the phosphorylated polyvinyl alcohol.

The deionized water absorption ratio, the calcium ion water absorption ratio, and the calcium ion water re-absorption ratio of the second water-absorbent resins (1) to (12) each composed of a crosslinked phosphorylated polyvinyl alcohol and the comparative water-absorbent resins (8) to (12) each composed of a crosslinked polyvinyl alcohol were measured, and the results are shown in Table 2. The methods for measuring the respective water absorption ratios are the same as described above, and the fact that the deionized water absorption ratio is denoted as water absorption ratio α, the calcium ion water absorption ratio is denoted as water absorption ratio β, and the calcium ion water re-absorption ratio is denoted as water absorption ratio γ applies also in Table 2.

TABLE 2

| | | |
|---|---|---|
| Water | Water | Water |
| absorption | absorption | absorption |
| ratio α | ratio β | ratio γ |

Second water-absorbent resin

| | | | |
|---|---|---|---|
| (1) | 50 | 21 | 21 |
| (2) | 52 | 21 | 22 |
| (3) | 30 | 20 | 20 |
| (4) | 56 | 19 | 22 |
| (5) | 163 | 24 | 34 |
| (6) | 98 | 22 | 27 |
| (7) | 89 | 22 | 26 |
| (8) | 106 | 19 | 29 |
| (9) | 52 | 21 | 22 |
| (10) | 136 | 23 | 31 |
| (11) | 189 | 24 | 37 |
| (12) | 121 | 23 | 29 |

Comparative water-absorbent resin

| | | | |
|---|---|---|---|
| (8) | 7 | 8 | 6 |
| (9) | 12 | 10 | 9 |
| (10) | 9 | 9 | 8 |
| (11) | Soluble | Soluble | Soluble |
| | in water | in water | in water |
| (12) | 7 | 8 | 6 |

As can be seen from the results in Table 2, the second water-absorbent resins (1) to (12) each composed of crosslinked phosphorylated polyvinyl alcohol are high in all water absorption ratios of the deionized water absorption ratio, the calcium ion water absorption ratio, and the calcium ion water re-absorption ratio, and exhibit good water absorbability even for hard water rich in calcium ions.

On the other hand, the water-absorbent resins (8) to (12) composed of crosslinked polyvinyl alcohol were low in water absorption ratio or were dissolved, and therefore were not suitable as water-absorbent resins.

### Example 1

A Wagner pot having a soil surface area of 1/5000 a (200 cm2) was prepared. On the other hand, a granular water-absorbent resin having a mass average particle diameter of 500 μm was prepared by pulverizing the film-like first water-absorbent resin (11). Mountain sand was spread as a culture medium on the Wagner pot, and improved soil composed of a mixture of 10 g of grained sand and 0.2 g of a granular water-absorbent resin was spread thereon, and smoothed. Then, sods (variety: Kentucky Bluegrass, trade name: VIVATURF, manufactured by NASU NURSERY INC.) cut with a hole cutter (Φ108 mm) were placed and spread thereon at the center of the improved soil, and gaps were filled with mountain sand. The turf was irrigated daily for one week until the turf took root. Then, the irrigation was stopped for one month with the influence of rainfall eliminated, and the condition of the turf was observed. As a result, the withering of the turf was prevented.

### Example 2

A Wagner pot having a soil surface area of 1/5000 a (200 cm2) was prepared. On the other hand, a granular water-absorbent resin having a mass average particle diameter of 500 μm was prepared by pulverizing the film-like second water-absorbent resin (9) composed of crosslinked phosphorylated polyvinyl alcohol. Mountain sand was spread as a culture medium on the Wagner pot, and improved soil composed of a mixture of 10 g of mountain sand and 0.1 g of a granular water-absorbent resin was spread thereon, and smoothed. Then, sods (variety: Kentucky Bluegrass, trade name: VIVATURF, manufactured by NASU NURSERY INC.) cut with a hole cutter (Φ108 mm) were placed and spread thereon at the center of the improved soil, and gaps were filled with mountain sand. The turf was irrigated once a day for 10 days until the turf took root, and then the irrigation was stopped for about 2 months with the influence of rainfall eliminated. Then, the root length of the turf was measured and found to be about 26 cm, and the leaf part was prevented from withering.

### Example 3

The root length of turf was measured by the same method as in Example 2 except that the amount of the granular water-absorbent resin used was changed to 0.2 g, and found to be about 21 cm, and the leaf part was prevented from withering.

### Comparative Example 1

The condition of the turf was observed by the same method as in Example 1 except that the granular water-absorbent resin was not used. As a result, most of the turf withered.

### Comparative Example 2

The root length of turf was measured by the same method as in Example 2 except that the granular water-absorbent resin was not used, and found to be about 8.5 cm, and the leaf part totally withered.

### Comparative Example 3

The root length of turf was measured by the same method as in Example 2 except that the granular water-absorbent resin was changed to a commercially available product (SuperSorb-F manufactured by The Aquatrols Company), and found to be about 8 to 12 cm.

### Comparative Example 4

The root length of turf was measured by the same method as in Example 3 except that the granular water-absorbent resin was changed to a commercially available product (SuperSorb-F manufactured by The Aquatrols Company), and found to be about 15 to 17 cm.

The results of Examples 1 to 3 show that in the improved soil using the first water-absorbent resin (11) or the second water-absorbent resin (9), the roots of turf grew well, and the growth of the turf was good. On the other hand, the results of Comparative Examples 1 and 2 show that when no water-absorbent resin is used, the growth of the roots of turf is poor, and the growth of the turf is poor. In addition, the results of Comparative Examples 3 and 4 show that when a commercially available water-absorbent resin was used, the growth of the roots of turf was small and the growth of the turf was insufficient as compared with the cases of Examples 2 and 3.

1. A method for growing a plant, the method comprising mixing a water-absorbent resin with soil into soil to obtain improved soil, and growing a plant on the improved soil,
wherein the water-absorbent resin includes a crosslinked polyvinyl alcohol and a crosslinked phosphorylated starch.

2. A method for growing a plant, the method comprising mixing a water-absorbent resin with soil to obtain improved soil, and growing a plant on the improved soil,
wherein the water-absorbent resin comprises a crosslinked phosphorylated polyvinyl alcohol.

3. The method for growing a plant according to claim 1, wherein the water-absorbent resin has a granular shape and has a mass average particle diameter of 50 to 1000 μm.

4. The method for growing a plant according to claim 1, wherein a water-absorbent nonwoven fabric having a water-absorbent resin supported on a nonwoven fabric is mixed into soil.

5. The method for growing a plant according to claim 4, wherein a water-absorbent nonwoven fabric having a water-absorbent resin supported on a nonwoven fabric by a binder is used.

6. The method for growing a plant according to claim 1, wherein the plant is turf.

7. A method for growing a plant, the method comprising growing a plant on a surface of the water-absorbent nonwoven fabric according to claim 4 in the absence of soil.

8. The method for growing a plant according to claim 7, wherein the water-absorbent nonwoven fabric is laid on a rooftop or a wall surface of a building.

9. A water-absorbent resin comprising a crosslinked polyvinyl alcohol and a crosslinked phosphorylated starch.

10. The water-absorbent resin according to claim 9, wherein the crosslinked polyvinyl alcohol is a crosslinked carboxylated polyvinyl alcohol and/or a crosslinked phosphorylated polyvinyl alcohol.

11. A method for producing the water-absorbent resin according to claim 9, the method comprising mixing polyvinyl alcohol, a phosphorylated starch, a crosslinking agent, and water to form a slurry, and heating the slurry to dryness at 100° C. to 140° C.

12. The method for producing a water-absorbent resin according to claim 11, wherein the polyvinyl alcohol is a carboxylated polyvinyl alcohol and/or a phosphorylated polyvinyl alcohol.

13. The method for producing a water-absorbent resin according to claim 12, wherein an aqueous solution obtained by mixing polyvinyl alcohol, phosphoric acid and/or a salt thereof, urea, and water is heated to dryness at 100° C. to 140° C. and washed to afford a phosphorylated polyvinyl alcohol.

14. The method for producing a water-absorbent resin according to claim 11, wherein the crosslinking agent is a compound selected from the group consisting of a polyfunctional isocyanate compound, a polyfunctional titanium compound, a polyfunctional epoxy compound, and a polyfunctional carboxylic acid.

15. A method for producing a water-absorbent nonwoven fabric, the method comprising impregnating a nonwoven fabric with the slurry according to claim 11, and then heating the nonwoven fabric to dryness at 100° C. to 140° C.
